(19) United States
(12) Patent Application Publication
(10) Pub. No.: US 2007/0121509 A1
(43) Pub. Date: May 31, 2007

(54) System and method for predicting updates to network operations

(75) Inventors: Michael Taylor, Brentwood, CA (US); Zesen Chen, Pleasanton, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/248,410

(22) Filed: Oct. 12, 2005

(51) Int. Cl. G08C 15/00; H04L 12/56

(52) U.S. Cl. 370/235; 370/395.21

(57) ABSTRACT

A system and method are disclosed for predicting updates to network operations. A system that incorporates teachings of the present disclosure may include, for example, a network management system (NMS) (100) having a memory (104), a communications interface (110), and a controller (102). The controller is programmed to observe (202) packet traffic in a network, and predict (208, 214) a need for updating operations of the network according to the packet traffic and one or more service level agreements (SLAs).

### FIELD OF THE DISCLOSURE

The present disclosure relates generally to network planning methods and more specifically to a system and method for predicting updates to network operations.

### BACKGROUND

Telecommunications providers commonly utilize network planning tools to determine when resources in a communications network may need updating. Today's network planning tools, however, often fail to predict resource shortfalls that might affect service level agreements (SLAs) with existing and prospective future customers.

### BRIEF DESCRIPTION OF THE DRAWINGS

FIG. 1 is a block diagram of communication system incorporating teachings of the present disclosure;

FIG. 2 depicts a flowchart of a method operating in a network management system according teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION

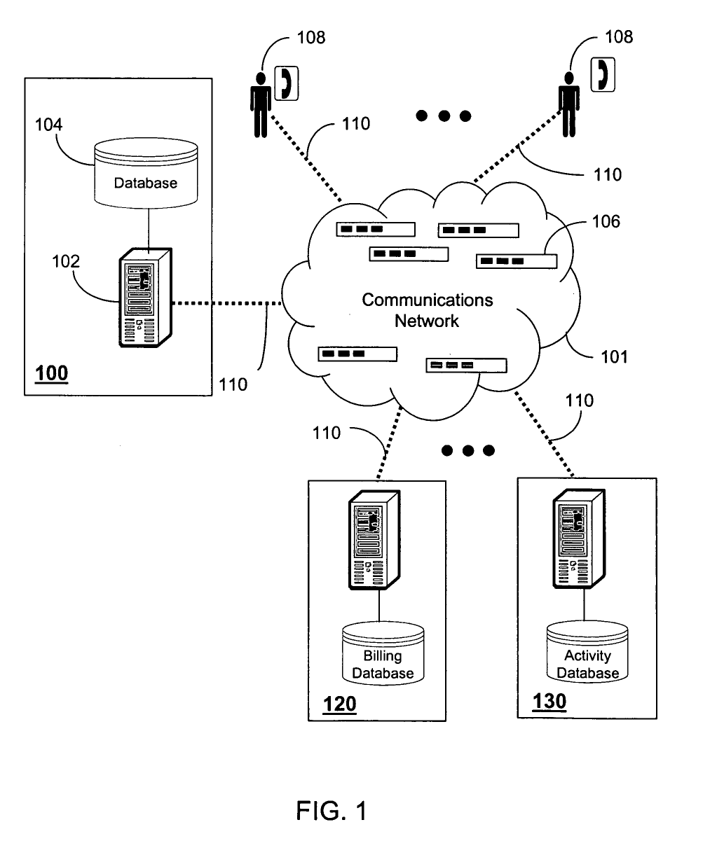

FIG. 1 is a block diagram of an NMS 100 coupled to a communications network 101 for serving customer needs according to teachings of the present disclosure. The NMS 100 comprises a communications interface 110, a memory 104 and a controller 102. The communications interface 110 utilizes wired or wireless communications technology for interfacing to the communications network 101. The communications interface 110 can be represented by a circuit switched and/or a packet switched interface.

The controller 102 utilizes computing technology such as a desktop computer, or a scalable server. The memory 104 utilizes mass storage media such as a high capacity disk drive that can be used by the controller 102 to manage one or more databases in accordance with the present disclosure. By way of the communications interface 110, the NMS 100 can access independently operated remote systems such as a billing system 120 and/or an activity-based tracking system 130 that can provide information relating to customer service uptake, churn, and other relevant information pertaining to operations of network 101. Although shown separately, the remote systems 120 and 130 can be in whole or in part an integral part of the NMS 100. The NMS 100 can also use the communications interface 110 to monitor packet traffic from each of a number of network elements 106 of the communications network 101. Network elements 106 can be represented by common telecommunication switches (such as SONET, DWDM, Ethernet, an Asynchronous Transfer Mode and Frame Relay switches) and/or or routers (such as an IP/Frame Relay routers).

In the present illustration, services provided to a customer 108 by network 101 can include Metropolitan Area Networks, Intranets, Internet, and traditional voice services. The communications network 101 can, for example, offer a number of services such as POTS (Plain Old Telephone Service), VoIP (Voice over Internet communications, IPTV (Internet Protocol Television), broadband communications, cellular telephony, and other known or future communication services.

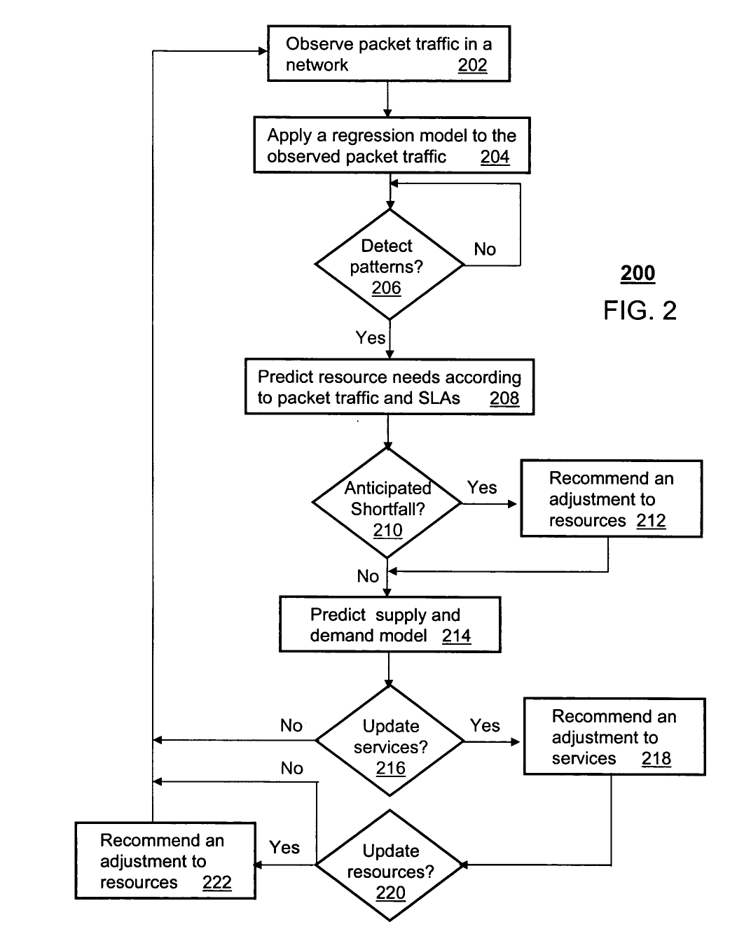

FIG. 2 depicts a flowchart of a method 200 operating in the NMS 100 according teachings of the present disclosure. Method 200 begins with step 202 where the NMS 100 is programmed to observe packet traffic of the network 101. The NMS 100 can be programmed to poll each of the network elements 106 for telemetry information. Alternatively, the network elements 106 can be programmed to autonomously send telemetry information to the NMS 100. Telemetry information can include common telemetry data such as, for example, traffic statistics including a rate of packet flow, traffic delay, loss of packets, jitter, congestion, and so on.

In step 204, the NMS 100 can apply regression analysis to the packet traffic telemetry data. With regression analysis, the NMS 100 can predict future events from correlated past events. Bayes' Theorem is a well-known and commonly used regression method. Named for Thomas Bayes, Bayesian logic is a branch of logic applied to decision making and inferential statistics that deals with probability inference using the knowledge of prior events to predict future events. Bayes first proposed his theorem in his 1763 work (published two years after his death in 1761), An Essay Towards Solving a Problem in the Doctrine of Chances. Bayes' theorem provides a mathematical method that can be used to calculate, given occurrences in prior trials, the likelihood of a target occurrence in future trials.

In accordance with Bayesian or like prediction techniques applied in step 204, the NMS 100 can detect traffic patterns in step 206. Upon detecting a pattern, the NMS 100 is programmed to predict in step 208 resource needs from the regression analysis according to packet traffic and one or more performance metrics of one or more corresponding SLAs which the service provider of the network 101 has agreed to support for corresponding customers 108 such as a mid to large-sized enterprise. An SLA can define as a performance metric an expected reliability of network services provided to a customer 108. Reliability metrics can include a threshold for mean time between failures, a maximum threshold for packet losses and retransmissions, a maximum network congestion threshold, and so on. It would be apparent to one of ordinary skill in the art that any performance metric of the network 101 can be applied to an SLA, which can be used in part in step 208 to make predictions on resource needs. In step 210, the NMS 100 can determine whether there is an anticipated shortfall between present resource capabilities and the predicted resource needs which may violate any one or more of the terms of service provisions of existing SLAs.

If the NMS 100 predicts a violation will occur in the near future, then the NMS 100 proceeds to step 212 where it presents resource adjustment recommendations. Said recommendations can include, for example, replacing, modifying, and/or adding one or more network resources to network 101. A recommendation can also include rerouting or reconfiguring traffic between network elements 106 to alleviate an anticipated nonconformance of one or more SLAs. A network resource in the present context can mean a network router such as an IP/Frame Relay router, and/or network switches such as SONET, DWDM, Ethernet, Asynchronous Transfer Mode and Frame Relay switches.

Whether or not there is an anticipated shortfall in network resources, the NMS 100 proceeds to step 214 where it predicts a supply and demand model from the detected patterns of step 206, and from other relevant information such as service cancellations, installations, complaints recorded or other relevant information recorded in the billing system 120, and/or the activity-based tracking system 130. In step 216, NMS 100 can check whether there is a need to update services provided by the network 101 according to the supply and demand model. If there is no anticipated need, then the NMS 100 proceeds to step 202 and repeats the foregoing steps.

If, on the other hand, the NMS 100 anticipates that demand will exceed supply, or supply will exceed demand, the NMS 100 can proceed to step 218 where it recommends an adjustment to services rendered by the network 101. The adjustment can include, for example, a recommendation to discontinue one or more existing services detected as not being in demand or profitable. The adjustment can also include a recommendation to modify and/or request new services based on patterns detected in customer 108 behavior.

In step 220, the NMS 100 can further check whether network resources need to be updated according to adjustments made in step 218. If, for example, a number of services are added to the network 101, said adjustment in services may require additional communication resources to maintain conformance to existing SLAs. Alternatively, cancellation of services may provide an opportunity to release resources that can be used to alleviate congestion in portions of the network 101. Thus, where an adjustment in services is made the NMS 100 can provide recommendations in step 222 for adjusting resources according to techniques similar to those described for step 212. Upon completing this step, the NMS 100 proceeds to step 202 where it repeats method 200.

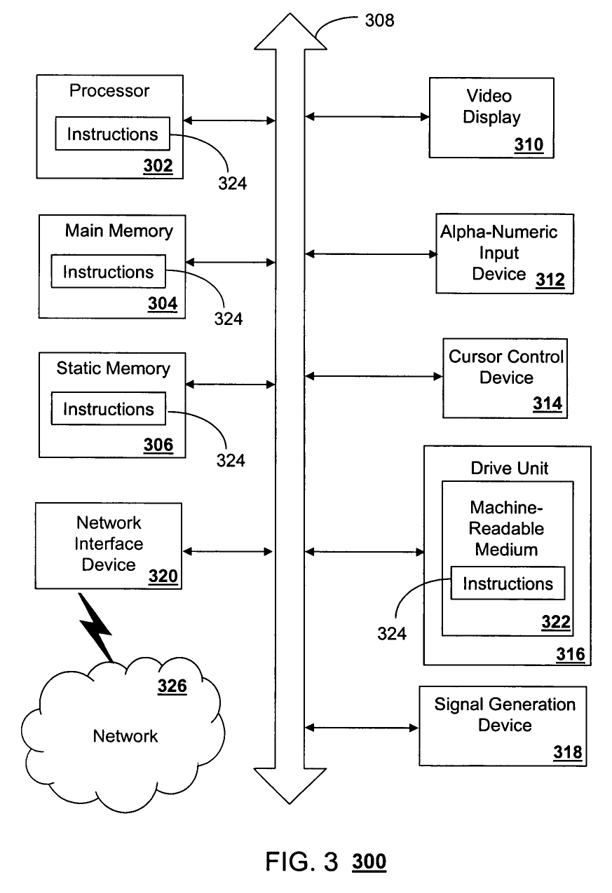

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network management system (NMS), comprising:
a communications interface; and
a controller for controlling operations of the communications interface, and programmed to:
observe packet traffic in a network; and
predict a need for updating operations of the network according to the packet traffic and one or more performance metrics of one or more corresponding service level agreements (SLAs).

2. The NMS of claim 1, wherein the controller is programmed to:
anticipate a shortfall in network resources to support one or more SLAs; and
recommend an adjustment to network resources to remedy the shortfall before its occurrence.

3. The NMS of claim 2, wherein the controller is programmed to recommend the adjustment according to a return on investment model.

4. The NMS of claim 2, wherein the recommendation comprises at least one among a replacement of one or more network resources, a modification to one or more network resources, and an addition of one or more network resources, and wherein a network resource comprises at least one among a network router and a network switch.

5. The NMS of claim 1, wherein the controller is programmed to:
predict a supply and demand model from the observed packet traffic; and
recommend an adjustment to operations according to the supply and demand model.

6. The NMS of claim 5, wherein the controller is programmed to predict from the supply and demand model a price model for one or more services of the network.

7. The NMS of claim 5, wherein the controller is programmed to predict from the supply and demand model an adjustment to services rendered by the network.

8. The NMS of claim 7, wherein the controller is programmed to adjust services according to at least one among a group comprising a discontinuation of one or more existing services, a modification to one or more existing services, and a request for one or more new services.

9. The NMS of claim 7, wherein the controller is programmed to recommend an adjustment to network resources according to the adjustment in services rendered.

10. The NMS of claim 1, wherein the controller is programmed to apply regression analysis on the packet traffic.

11. The NMS of claim 1, wherein the controller is programmed to predict the need for updating network resources of the network according to Bayes' Theorem.

12. A computer-readable storage medium, comprising computer instructions for:
observing packet traffic in a network;
applying regression analysis to the observed packet traffic;
detecting patterns in the packet traffic;
predicting a need for updating operations of the network according to said patterns and one or more performance metrics of one or more corresponding service level agreements (SLAs).

13. The storage medium of claim 12, comprising computer instructions for:
predicting a number of future SLAs;
anticipating a shortfall in network resources to support the future SLAs; and
recommending an adjustment to network resources to remedy the shortfall before its occurrence according to a return on investment model.

14. The storage medium of claim 12, comprising computer instructions for:
predicting a supply and demand model from the detected patterns; and
recommending at least one among a price model for one or more services of the network, a price model for SLAs, and an adjustment to services rendered by the network.

15. The storage medium of claim 14, comprising computer instructions for adjusting services according to at least one among a group comprising a discontinuation of one or more existing services, a modification to one or more existing services, and a request for one or more new services.

16. The storage medium of claim 14, comprising computer instructions for recommending an adjustment to network resources according to the adjustment in services rendered.

17. The storage medium of claim 12, comprising computer instructions for:
applying Bayes' Theorem on the packet traffic; and
detecting said patterns in the packet traffic according to Bayes' Theorem.

18. A method, comprising the steps of:
applying regression analysis to observed packet traffic;
detecting patterns in the packet traffic;
predicting a need for adjusting operations of the network according to said patterns and one or more performance metrics of one or more corresponding SLAs.

19. The method of claim 18, comprising the steps of:
anticipating a shortfall in network resources to support the SLAs; and
reconfiguring the network to remedy the shortfall before its occurrence.

20. The method of claim 19, comprising the step of reconfiguring the network according to at least one among a group of steps comprising:
rerouting of the packet traffic according to the detected patterns;
replacing one or more existing network resources;
modifying one or more existing network resources; and
adding one or more new network resources.
